(19) United States
(12) Patent Application Publication
(10) Pub. No.: US 2024/0402954 A1
(43) Pub. Date: Dec. 5, 2024

(54) IMAGE PROCESSING APPARATUS, IMAGE PROCESSING METHOD, AND NON-TRANSITORY STORAGE MEDIUM STORING IMAGE PROCESSING PROGRAM

(71) Applicant: Konica Minolta, Inc., Tokyo (JP)

(72) Inventor: Keishi SAKUMA, Tokyo (JP)

(73) Assignee: Konica Minolta, Inc., Tokyo (JP)

(21) Appl. No.: 18/663,325

(22) Filed: May 14, 2024

(30) Foreign Application Priority Data
May 31, 2023 (JP) 2023-090109

(51) Int. Cl. G06F 3/12

(52) U.S. Cl. CPC G06F 3/1217; G06F 3/1236; G06F 3/1241

(57) ABSTRACT

An image processing apparatus distributes raster image processor (RIP) processing of a print job that is divided into pages to the image processing apparatus itself and another image processing apparatus with which there is a network connection. The image processing apparatus may comprise a hardware processor configured to: predict, for each page of the print job, a state of a RIP-processed image of the page when the other image processing apparatus is allocated the page for RIP processing; and allocate, for each page of the print job, RIP processing of the page to the image processing apparatus itself or the other image processing apparatus based on the state of a RIP-processed image of the page.

### CROSS-REFERENCE STATEMENT

The present application is based on, and claims priority from, Japanese Patent Application Number 2023-090109, filed May 31, 2023, the disclosure of which is hereby incorporated by reference herein in its entirety.

### BACKGROUND

### Technical Field

The disclosure relates to an image processing apparatus, an image processing method, and a non-transitory storage medium storing an image processing program.

### Description of Related Art

An image processing apparatus (a controller) that performs raster image processor (RIP) processing of a print job performs print control of a printer. Here, the RIP processing is processing for converting image data (e.g., PDF data) into bitmap data that can be printed by a printer.

For an industrial digital printer that is capable of handling a large-size paper, image data size of a print job to be handled is very large. For example, for a printer that is capable of handling a maximum paper size of size B2, an image data size of a print job per page after RIP processing is about 4 gigabytes (GB).

In view of this, a technique is disclosed in which RIP processing for a print job is divided into predetermined processing units and subjected to distributed processing (for example, Japanese Unexamined Patent Application Publication No. 2016-093984 [hereinafter Patent Literature 1]). Patent Literature 1 describes a technique in which RIP processing is divided into predetermined processing units, a processing load of each of the divided RIP processing is predicted, and, based on the predicted processing loads and processing states of a plurality of rasterizing units (rasterizing devices) in charge of distributed processing, an end time of each of the divided RIP processing is predicted. Then, to achieve efficient distributed processing of the print job, RIP processing is allocated so that the difference in processing end times of individual RIP processing becomes small.

However, with the technology described in Patent Literature 1, in cases where distributed processing of RIP is implemented by an own image processing apparatus and a plurality of image processing apparatuses connected via a network, data transfer speed of a RIP-processed image via the network becomes a bottleneck. Thus, cases will arise where sufficient performance improvement cannot be expected from the distributed processing.

More specifically, when RIP processing of a page whose image after RIP processing has a low compression ratio is allocated to an external image processing apparatus and large-sized data needs to be transferred via the network, performance that is expected from distributed processing may not be achieved or performance may even drop through distributed processing.

### SUMMARY

The disclosure has been made in view of the above circumstances, and it is an object of the disclosure to prevent a decrease in performance when RIP processing of a print job is performed in a distributed manner by a plurality of image processing apparatuses that are connected via a network and communication speed of the network can be a restriction to the performance.

The above object of the disclosure is achieved by the following configurations.

An aspect of the disclosure provides an image processing apparatus that distributes raster image processor (RIP) processing of a print job that is divided into pages to the image processing apparatus itself and another image processing apparatus with which there is a network connection. The image processing apparatus may comprise a hardware processor that is configured to: predict, for each page of the print job, a state of a RIP-processed image of the page when the other image processing apparatus is allocated the page for RIP processing; and allocate, for each page of the print job, RIP processing of the page to the image processing apparatus itself or the other image processing apparatus based on the state of a RIP-processed image of the page.

Another aspect of the disclosure provides an image processing method of an image processing apparatus that distributes raster image processor (RIP) processing of a print job that is divided into pages to the image processing apparatus itself and another image processing apparatus with which there is a network connection. The image processing method may comprise: predicting, for each page of the print job, a state of a RIP-processed image of the page when the other image processing apparatus is allocated the page for RIP processing; and allocating, for each page of the print job, RIP processing of the page to the image processing apparatus itself or the other image processing apparatus based on the state of a RIP-processed image of the page.

Another aspect of the disclosure provides a non-transitory computer readable storage medium storing a program causing a computer to perform operations of an image processing apparatus that distributes raster image processor (RIP) processing of a print job that is divided into pages to the image processing apparatus itself and another image processing apparatus with which there is a network connection. The operations include: predicting, for each page of the print job, a state of a RIP-processed image of the page when the other image processing apparatus is allocated the page for RIP processing; and allocating, for each page of the print job, RIP processing of the page to the image processing apparatus itself or the other image processing apparatus based on the state of a RIP-processed image of the page.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a diagram illustrating an overall configuration of a printing system that may comprise an image processing apparatus according to an embodiment.

FIG. 2 is a diagram illustrating another example of an overall configuration of a printing system that may comprise an image processing apparatus according to an embodiment.

FIG. 3 is a functional block diagram that illustrates a configuration of an image processing apparatus according to an embodiment.

FIG. 4 is a sequence diagram illustrating overall processing steps of a printing system that may comprise an image processing apparatus according to an embodiment.

FIG. 5 is a flowchart illustrating steps of page allocation processing executed by an image processing apparatus according to an embodiment.

### DETAILED DESCRIPTION OF EMBODIMENTS

Hereinafter, one or more embodiment s of the present invention will be described with reference to the drawings. However, the scope of the invention may be not limited to the disclosed embodiments.

An embodiment of the disclosure (hereinafter referred to as the “present embodiment”) will be described with reference to the drawings. Note that in all the drawings of the present specification, constituent parts having corresponding functions are denoted by the same reference signs, and description thereof may be omitted as appropriate.

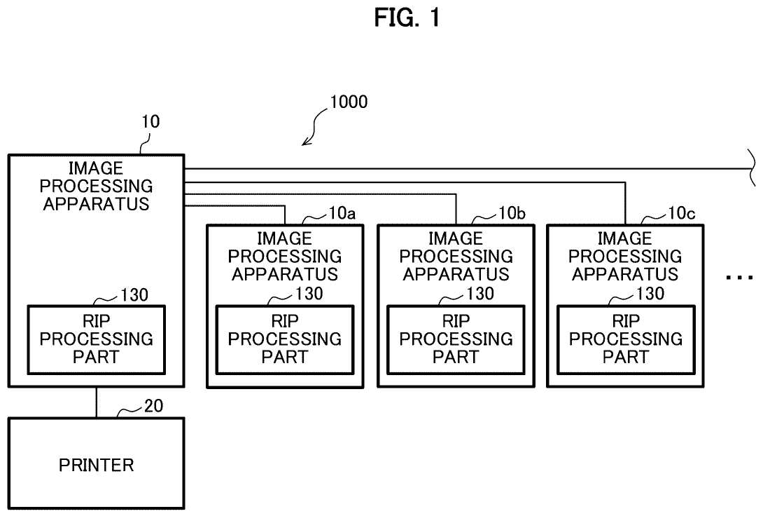

FIG. 1 is a diagram illustrating an overall configuration of a printing system 1000 that may comprise an image processing apparatus 10 according to the present embodiment.

The printing system 1000 may comprise a printer 20, an image processing apparatus 10 that may be connected to the printer 20, and a plurality of image processing apparatuses 10a, 10b, and 10c that are connected to the image processing apparatus 10 via a network.

The image processing apparatus 10 may be a controller that retains, manages, and executes a print job. The image processing apparatus 10 may comprise functionality to perform RIP processing (a RIP processing part 130 to be described later). Further, the image processing apparatus 10 performs control of the entire system, such as dividing a print job, allocating a RIP process to each of the image processing apparatuses 10a, 10b, and 10c, and transmitting an image that has been RIP processed to the printer 20, at the time of RIP processing of the print job.

The printer 20 may be a device that receives an image that has been RIP processed from the image processing apparatus 10 that may be connected to the printer 20 and prints the image.

Each of the image processing apparatuses 10a, 10b, and 10c may comprise functionality to perform RIP processing (a RIP processing part 130). Each of the image processing apparatuses 10a, 10b, and 10c may be configured to, in accordance with a RIP processing request from the image processing apparatus 10, receive a print job, perform RIP processing, compress RIP-processed image data, and send the compressed image data to the image processing apparatus 10. The image processing apparatuses 10a, 10b, and 10c are extension nodes for the image processing apparatus 10 serving as a master node. The number of image processing apparatus serving as an extension node is not limited to three as illustrated in FIG. 1 and may be one or more.

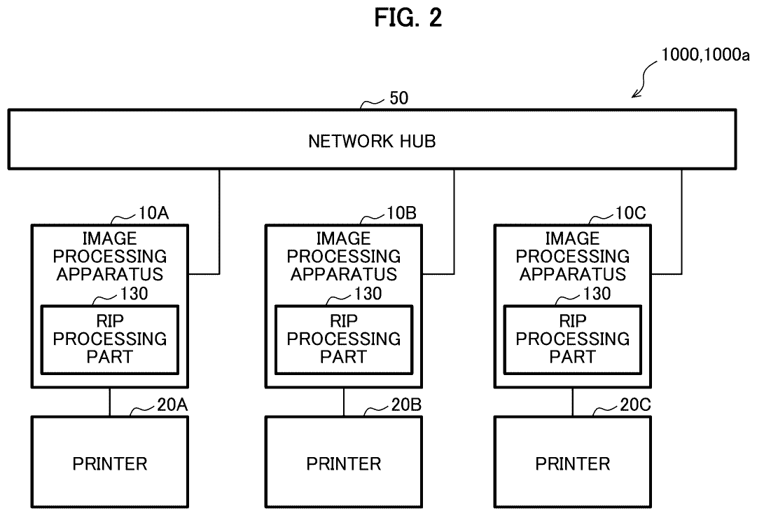

FIG. 2 is a diagram illustrating another example of an overall configuration of a printing system 1000 (1000a) including an image processing apparatus 10 according to the present embodiment.

As illustrated in FIG. 2, the printing system 1000a may comprise a plurality of image processing apparatuses 10 (10A, 10B, and 10C) connected via a network hub 50 and printers 20 (20A, 20B, and 20C) connected to the image processing apparatuses 10.

In the printing system 1000a, each of the image processing apparatuses 10 (10A, 10B, and 10C) may comprise functionality to execute RIP processing (RIP processing part 130) and functionality to retain, manage, and execute a print job. One of the image processing apparatuses 10 (10A, 10B, and 10C) connected to a printer 20 that prints the print job becomes a master node. An image processing apparatus 10 (an “other image processing apparatus”) other than the image processing apparatus 10 serving as the master node acts as an extension node. In accordance with a RIP processing request from the master node, the other image processing apparatus 10 serving as the extension node receives a print job, performs RIP processing, performs compression of image data that has been RIP processed, and transmits the compressed image data to the image processing apparatus 10 serving as the master node.

Note that the following description will be given on the premise of the printing system 1000 illustrated in FIG. 1. However, the same process may be performed by the printing system 1000a of FIG. 2 with any one of the image processing apparatuses 10 (10A, 10B, and 10C) serving as the master node.

### Image Processing Apparatus

Next, an image processing apparatus 10 according to the present embodiment will be described in detail.

The image processing apparatus 10 according to the present embodiment divides a print job into units of pages and performs RIP processing on individual pages (into which the print job has been divided) in a distributed manner by using the image processing apparatuses 10a, 10b, and 10c connected via the network. When allocating individual pages of the print job to the image processing apparatuses 10a, 10b, and 10c, the image processing apparatus 10 determines an optimal page allocation for distributed processing based on measurements of network communication speed between the image processing apparatus 10 and the image processing apparatuses 10a, 10b, and 10c that are connected through a network and a prediction of an image state (compression ratio, data size) after RIP processing of each page of the print job.

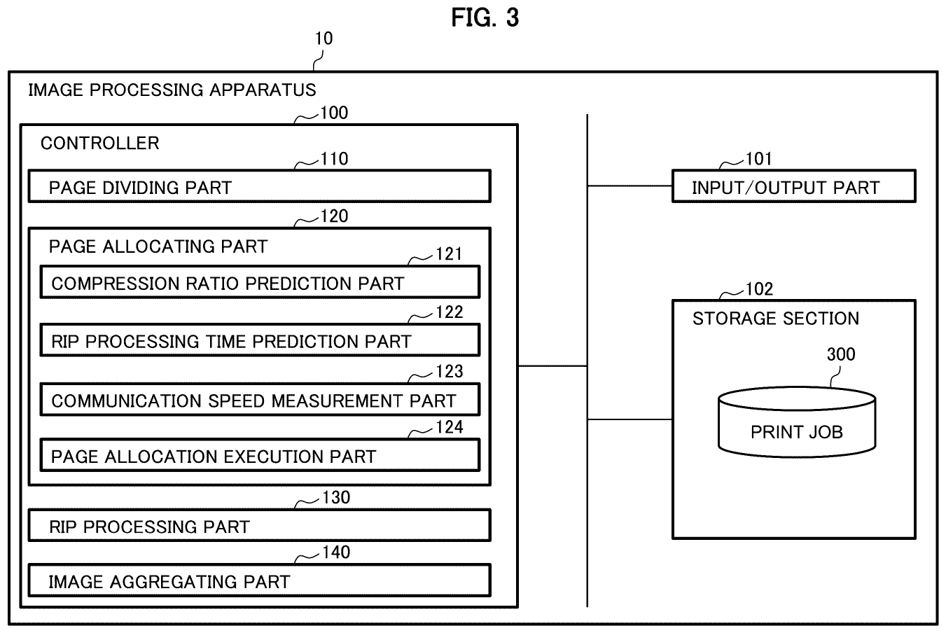

FIG. 3 is a functional block diagram that illustrates a configuration of the image processing apparatus 10 according to the present embodiment.

As illustrated in FIG. 3, the image processing apparatus 10 may comprise a controller 100, an input/output part 101, and a storage section (storage) 102. The image processing apparatus 10 may be a computer that may comprise a processor (not illustrated) and a storage section 102, and implements each functional part by executing a program (image processing program; not illustrated). The program (image processing program) may be stored in a non-transitory storage medium (not illustrated). The non-transitory storage medium may be a memory storage medium, an optical storage medium, a magnetic storage medium, or the like. The program may be installed on the image processing apparatus 10 from the non-transitory storage medium directly, via an information reading unit (not illustrated), or indirectly, via a communication line (not illustrated).

The input/output part 101 inputs and outputs information to and from other devices (such as the printer 20 and other image processing apparatuses 10a, 10b, and 10c). The input/output part 101 may comprise a communication interface (network interface) and an input/output interface. The communication interface transmits and receives information via a communication line. The input/output interface inputs and outputs information to and from the printer 20, an input device such as a keyboard (not illustrated), and an output device such as a monitor.

The storage section 102 may comprise a solid state drive (SSD), a hard disk, a flash memory, a random access memory (RAM), or the like.

The storage section 102 temporarily stores therein the program (image processing program) for implementing functional parts of the controller 100. Further, the storage section 102 temporarily stores therein information used for processing by the controller 100.

Note that the storage section 102 stores therein a print job 300 that may be data to be printed by the printer 20 connected to the image processing apparatus 10. The storage section 102 may also store therein “compression ratio history information” used for calculating a compression ratio prediction value (to be described later) and/or “RIP processing time history information” used for calculating predicted RIP-processing time (details will be described later).

The controller 100 controls overall processing executed by the image processing apparatus 10. The controller 100 may comprise a page dividing part 110, a page allocating part 120, a RIP processing part 130, and an image aggregating part 140.

The page dividing part 110 reads a print job 300 stored in the storage section 102 and divides the print job 300 into units of pages.

The page allocating part 120 predicts an image state (compression ratio, data size) of individual pages of the print job after RIP processing by the other image processing apparatuses 10a, 10b, and 10c. Further, the page allocating part 120 determines which of the image processing apparatuses including itself 10, 10a, 10b, and 10c may be to process job data of each page (into which the print job has been divided) based on the predicted image state after RIP processing. Then, the page allocating part 120 sends the job data to the RIP processing part 130 of an image processing apparatus 10, 10a, 10b, or 10c that has been determined to process said job data.

When executing page allocation control to allocate pages to RIP processing parts 130, the page allocating part 120 executes the following processes as preliminary processes: (1) a process to determine a compression ratio prediction value of each page of the print job; (2) a process to predict RIP processing time of each page of the print job; and (3) a process to measure network communication speed between the image processing apparatus 10 and the image processing apparatuses 10a, 10b, and 10c (details will be described later).

As illustrated in FIG. 3, the page allocating part 120 may comprise a compression ratio prediction part 121, a RIP processing time prediction part 122, a communication speed measurement part 123, and a page allocation execution part 124.

The compression ratio prediction part 121 predicts a compression ratio of each page of the print job 300 after RIP processing.

Specifically, the compression ratio prediction part 121 acquires information (hereinafter referred to as “object configuration information”) of each page by a preflight process (a process of determining in advance validity for a print process and various conditions that can be specified) of the print job 300. The object configuration information of each page may comprise attribute information of an object configuring the page, resolution, and the number of objects.

The image processing apparatus 10 creates, in advance, information (hereinafter referred to as “compression ratio history information”) that indicates a relationship between the object configuration information and compression ratio after RIP processing based on past data. Then, the compression ratio prediction part 121 determines a predicted value of a compression ratio of each page after RIP processing (“compression ratio prediction value”) with reference to the compression ratio history information and based on the attribute information of an object configuring each page, resolution, the number of objects, or the like obtained by analyzing each page of the print job 300.

A predicted size of compressed data (data size) of image data after RIP processing (RIP-processed image data) may be calculated for each page based on the compression ratio prediction value of said each page after RIP processing and data size of job data of said each page.

The compression ratio history information may be stored in advance in the storage section 102 of the image processing apparatus 10. In one or more embodiments, the compression ratio history information may be provided in an external device, and the compression ratio prediction part 121 of the image processing apparatus 10 may make an inquiry with said external device.

The RIP processing time prediction part 122 determines, for each page of the print job 300, time required for RIP processing as the predicted RIP-processing time.

Based on past data, the image processing apparatus 10 creates, in advance, information (hereinafter referred to as “RIP processing time history information”) indicating a relationship between object configuration information of a page (information including attribute information of an object configuring the page, resolution, and the number of objects) and RIP processing time of a page according to a predetermined CPU processing performance serving as a reference. Then, the RIP processing time prediction part 122 determines the predicted RIP-processing time of each page with reference to the RIP processing time history information and based on the object configuration information obtained by the preflight process.

Note that the RIP processing time history information may be stored in advance in the storage section 102 of the image processing apparatus 10. In one or more embodiments, the RIP processing time history information may be provided in an external device and the RIP processing time prediction part 122 of the image processing apparatus 10 may make an inquiry with said external device.

The communication speed measurement part 123 measures communication speed (delay time) between the image processing apparatus 10 and each of the other image processing apparatuses 10a, 10b, and 10c by using, for example, an existing delay measurement tool that uses a command such as ping, iperf, or netperf. At this time, the communication speed measurement part 123 measures the delay time using, for example, test files of different data sizes so that delay time corresponding to a data size can be calculated for each of the other image processing apparatuses 10a, 10b, and 10c.

The measurement of the communication speed (delay time) by the communication speed measurement part 123 may be performed at a predetermined time interval or may be performed immediately before the page allocating part 120 executes a page allocation processing.

The page allocation execution part 124 allocates each page of the print job 300 to one of the image processing apparatuses (10, 10a, 10b, and 10c). Note that in the description herein, the image processing apparatus 10 connected to the printer 20 may be referred to as the “master node” and the image processing apparatuses (10a, 10b, and 10c) that receive allocations of pages of the print job 300 from the image processing apparatus 10 are referred to as the “extension nodes”.

In the page allocation processing, first, the page allocation execution part 124 determines an upper limit of the number of pages allocated to an extension node and an upper limit of data size.

The upper limit of the number of pages allocated to an extension node may be determined according to a ratio between arithmetic processing capability of the master node and arithmetic processing capability of each extension node. For example, for a configuration of one master node and two extension nodes that each have the same arithmetic processing capability, a ratio on the number of pages that may be allocated may be set to 1:1:1. Then, the upper limit of the number of allocated pages for each extension node may be determined from the number of pages of the entire print job.

The upper limit of data size may be defined as an upper limit of a total value of predicted compressed data size after RIP processing of one or more pages that are allocated to each extension node.

The upper limit of data size may be set based on predicted time, N seconds, of RIP processing in a case where all pages of the print job 300 are processed by the master node. Data size resulting in data transfer time of N seconds or less when network communication speed may be at a value that has been measured in advance for an extension node may be set as the upper limit for the extension node.

By limiting the total value of the predicted compressed data size of one or more pages allocated to the extension node to be equal to or less than the upper limit, it may be possible to prevent the transfer of RIP-processed image data from the extension node to the master node from taking N seconds or more, the N seconds being the processing time when all the pages of the print job 300 are processed by the master node.

The page allocation execution part 124 selects pages in order so that an unallocated page having the highest compression ratio prediction value may be selected out of all the pages of the print job 300. The page allocation execution part 124 then calculates a timing of transmission by the extension node to the image aggregating part 140 of a RIP-processed image calculated from the network communication speed and the predicted RIP-processing time when the selected page may be allocated to the extension node. The page allocation execution part 124 then determines whether this timing of transmission by the extension node will be in time for a transmission timing of transmitting print data (image data after RIP processing) to the printer 20 by the image aggregating part 140. When it is determined that the timing of transmission by the extension node will be in time, the page allocation execution part 124 allocates the selected page to the extension node. When it is determined that the timing of transmission by the extension node will not be in time, the page allocation execution part 124 allocates the selected page to the master node.

When the page is allocated, the page allocation execution part 124 determines whether or not either the number of one or more pages allocated to the extension node connected via the network or the total value of compressed data size after RIP processing has reached the respective upper limit. When the upper limit has not been reached, the page allocation execution part 124 repeats the allocation processing of a page to the extension node. When the upper limit has been reached, the page allocation execution part 124 allocates all of one or more unallocated pages that are remaining to the master node.

The RIP processing part 130 performs RIP processing on the one or more pages allocated by the page allocating part 120.

Note that the RIP processing part 130 of the extension node executes RIP processing upon receiving job data of corresponding one or more pages of the print job 300 from the master node. The RIP processing part 130 of the extension node compresses RIP-processed image data and transmits the compressed image data to the image aggregating part 140 of the master node.

The image aggregating part 140 acquires image data that has undergone RIP processing from the RIP processing part 130 of the master node and the RIP processing part 130 of each extension node and outputs the RIP-processed image data to the printer 20 in an appropriate order (page order) and at an appropriate timing.

### Flow of Processing

Next, a description may be given of a processing flow of a printing system 1000 that may comprise an image processing apparatus 10.

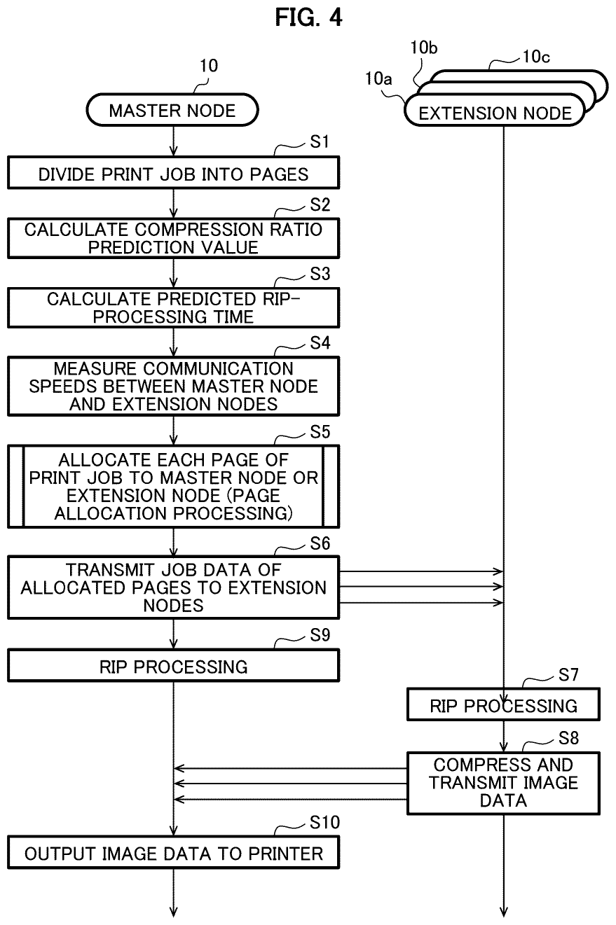

FIG. 4 is a sequence diagram illustrating a flow of overall processing of the printing system 1000 that may comprise the image processing apparatus 10 according to the present embodiment.

Here, in the printing system 1000 illustrated in FIG. 1, the image processing apparatus 10 connected to the printer 20 may be referred to as a “master node”, and the image processing apparatuses (10a, 10b, and 10c) that receive allocation of one or more pages of the print job 300 from the image processing apparatus 10 are referred to as “extension nodes”.

First, the page dividing part 110 of the image processing apparatus 10 (master node) reads the print job 300 stored in the storage section 102 and divides the print job 300 into units of pages (step S1).

Next, the page allocating part 120 (compression ratio prediction part 121) of the master node executes preflight processing for each page of the print job 300 to acquire, for each page, information (object configuration information) such as attribute information of an object constituting the page, resolution of an object, and the number of one or more objects that are included in the page.

Then, the compression ratio prediction part 121 calculates a compression ratio prediction value of each page with reference to the compression ratio history information indicating a relationship between the object configuration information and the compression ratio of an image after RIP processing (step S2). The compression ratio prediction part 121 calculates predicted compressed data size of RIP-processed image data from data size of each page and the calculated compression ratio prediction value of each page.

Then, the page allocating part 120 (the RIP processing time prediction part 122) calculates predicted RIP-processing time of each page with reference to the RIP processing time history information that indicates a relationship between object configuration information and RIP processing time of a page according to a predetermined CPU processing performance serving as a reference (step S3).

The page allocating part 120 (the communication speed measurement part 123) measures communication speeds (delays) between the image processing apparatus 10 and the other image processing apparatuses 10a, 10b, and 10c (extension nodes) (step S4).

As measurements of the communication speeds between the master node and the extension nodes, measurement information that has been obtained in advance at a predetermined time interval may be used.

Then, the page allocating part 120 (the page allocation execution part 124) of the master node allocates each page of the print job 300 to one of the image processing apparatuses (the master node and extension nodes) (step S5).

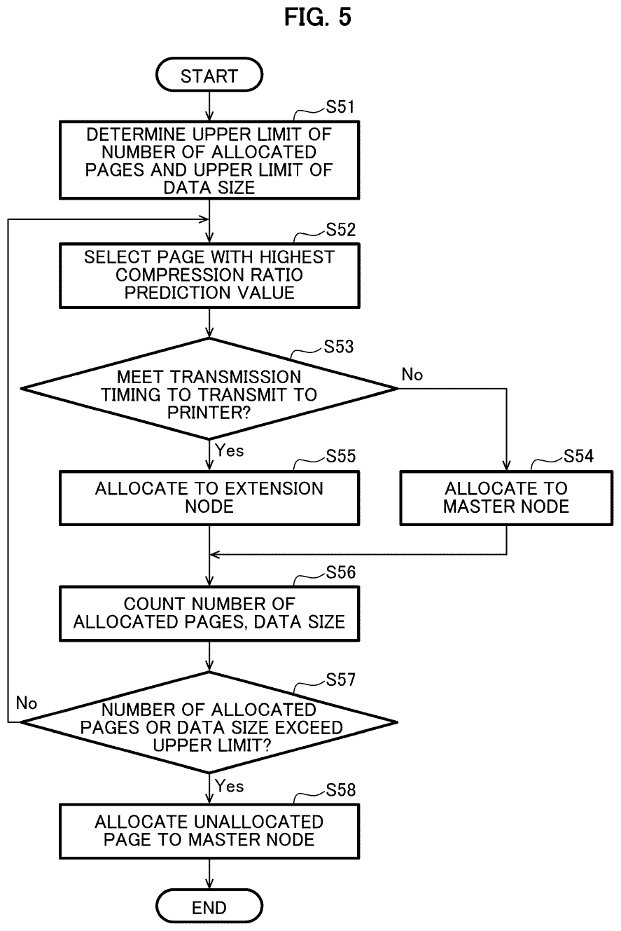

The page allocation execution part 124 selects unallocated pages in descending order of compression ratio prediction values. The page allocation execution part 124 allocates a selected page to an extension node when it may be determined that the transmission timing of transmitting a RIP-processed image to the printer 20 will be met, and allocates the selected page to the master node when it may be determined that the transmission timing will not be met (see FIG. 5 for details).

Then, the page allocation execution part 124 transmits job data of pages that have been determined to be allocated to the extension nodes to the RIP processing parts 130 of the extension nodes (step S6). Also, the page allocating part 120 outputs job data of a page that have been determined to be allocated to itself (the master node) to its own RIP processing part 130.

The RIP processing part 130 of an extension node sequentially performs RIP processing on the received job data of each page (step S7), compresses the RIP-processed image data, and transmits the compressed, RIP-processed image data to the image aggregating part 140 of the master node (step S8).

The RIP processing part 130 of the master node performs RIP processing on the job data of the page allocated to itself (step S9). Then, the image data after RIP processing may be outputted to the image aggregating part 140.

Next, the image aggregating part 140 of the master node acquires the RIP-processed image data from the RIP processing part 130 of itself (the master node) and the RIP processing parts 130 of the respective extension nodes, and outputs individual RIP-processed image data to the printer 20 in an appropriate order (page order) and at an appropriate timing (step S10). As a result, printing of the print job 300 may be executed by the printer 20.

### Page Allocation Processing

Next, a page allocation processing executed by the page allocation execution part 124 of the image processing apparatus 10 will be described in detail.

FIG. 5 is a flowchart illustrating a flow of a page allocation processing executed by the image processing apparatus 10 according to the present embodiment. This page allocation processing may be executed in step S5 of FIG. 4.

First, the page allocation execution part 124 of the image processing apparatus 10 (master node) determines an upper limit of the number of pages allocated to each extension node and an upper limit of data size (step S51).

Here, the page allocation execution part 124 determines the upper limit of the number of allocated pages based on a ratio of arithmetic processing capabilities of the master node and each of the extension nodes and on the number of pages of the entire print job 300. In other words, the upper limit may be set such that a larger number of pages are allocated for a higher processing capability.

Furthermore, the page allocation execution part 124 calculates predicted time (N seconds) for RIP processing in a case where all the pages of the print job 300 are processed by the master node, and sets, for each extension node, the upper limit of data size so that data transfer time may be N seconds or less for the network communication speed with the extension node.

Subsequently, the page allocation execution part 124 selects a page having the highest compression ratio prediction value calculated in step S2 of FIG. 4 from unallocated pages out of all pages of the print job 300 (step S52).

Then, the page allocation execution part 124 determines whether or not RIP processing of the selected page by an extension node will be in time for a transmission timing of transmitting image data to the printer 20 (step S53).

Here, the page allocation execution part 124 determines whether or not a result of performing RIP processing by a selected extension node will be received by the master node in time for the transmission timing of transmitting image data to the printer 20 from the network communication speed, a compression ratio of image data after RIP processing (a data size of compressed data obtained by compressing a RIP-processed image), and a predicted RIP-processing time.

The selection of an extension node to perform RIP processing may be performed based on a predetermined extension node selection logic. For example, the extension node may be selected in ascending order of the IDs of the extension nodes or may be selected at random. Furthermore, the extension node may be selected in descending order of processing performance of the extension nodes. In a case where the extension node selected by the predetermined extension node selection logic is not able to meet the transmission timing of transmitting image data, the page allocation execution part 124 selects another extension node and sequentially determines whether or not the transmission timing of transmitting image data is able to be met. Then, when none of the extension nodes are able to meet the transmission timing of transmitting image data, the page allocation execution part 124 finally determines that the transmission timing of transmitting image data to the printer 20 is not able to be met.

Then, when the page allocation execution part 124 determines that the transmission timing is not able to be met (step S53→No), the page allocation execution part 124 allocates the selected page to the master node (step S54) and proceeds to the next step S56.

On the other hand, when the page allocation execution part 124 determines that the transmission timing is able to be met by a selected extension node performing RIP processing (step S53→Yes), the page allocation execution part 124 allocates the selected page to the selected extension node (step S55) and proceeds to the next step S56.

In step S56, the page allocation execution part 124 counts the number of pages allocated to the master node and each extension node (the number of allocated pages), and counts (totals) the data size of compressed image data for each selected extension node.

Next, the page allocation execution part 124 determines whether the number of one or more pages allocated to each extension node has reached the upper limit of the number of pages allocated to the extension node or the total data size of compressed image data has reached the upper limit of data size (step S57).

If neither the upper limit of the number of allocated pages nor the upper limit of data size is reached (step S57→No), the process returns to step S52 and the process continues.

On the other hand, when either the upper limit of the number of allocated pages or the upper limit of data size is reached (step S57→Yes), the process proceeds to step S58.

In step S58, the page allocation execution part 124 allocates an unallocated page to the master node and ends the process.

In this way, when RIP processing of a print job is distributed among a plurality of image processing apparatuses 10a, 10b, and 10c with which the image processing apparatus 10 is connected via a network, it may be possible to prevent performance degradation due to restriction caused by communication speed of the network.

Note that the disclosure may not be limited to the above-described embodiments, and various changes and modifications can be made without departing from the scope of the disclosure.

### Aspects of the Disclosure

(1) A first aspect of the disclosure provides an image processing apparatus that distributes raster image processor (RIP) processing of a print job that may be divided into pages to the image processing apparatus itself and another image processing apparatus with which there may be a network connection. The image processing apparatus may comprise a hardware processor that may be configured to: predict, for each page of the print job, a state of a RIP-processed image of the page when the other image processing apparatus is allocated the page for RIP processing; and allocate, for each page of the print job, RIP processing of the page to the image processing apparatus itself or the other image processing apparatus based on the state of a RIP-processed image of the page.

(2) A second aspect of the disclosure provides the image processing apparatus according to the first aspect, in which the state of a RIP-processed image of the page may be a compression ratio when the RIP-processed image is compressed.

(3) A third aspect of the disclosure provides the image processing apparatus according to the first aspect, in which the state of a RIP-processed image of the page may be a data size of compressed data obtained by compressing the RIP-processed image.

(4) A fourth aspect of the disclosure provides the image processing apparatus according to the first aspect, in which the state of a RIP-processed image of the page may be predicted based on object configuration information, the object configuration information including attribute information of an object that constitutes said page, resolution, and a number of one or more objects of said page.

(5) A fifth aspect of the disclosure provides the image processing apparatus according to the first aspect, in which the hardware processor may be configured to: measure a network communication speed between the image processing apparatus itself and the other image processing apparatus; and allocate, for each page of the print job, RIP processing of the page to the image processing apparatus itself or the other image processing apparatus based on the measured network communication speed and the state of a RIP-processed image of the page.

(6) A sixth aspect of the disclosure provides the image processing apparatus according to the fifth aspect, in which the hardware processor may be configured to: calculate, as predicted RIP-processing time, time taken to perform RIP processing of each page of the print job by the other image processing apparatus; and allocate, to the other image processing apparatus, a page that may be transmitted in time for a transmission timing of transmitting RIP-processed images to a printer based on the network communication speed, the state of a RIP-processed image of each page of the print job, and the calculated, predicted RIP-processing time of each page of the print job.

(7) A seventh aspect of the disclosure provides the image processing apparatus according to the sixth aspect, in which the hardware processor may be configured to: perform the following operations for pages of the print job starting with a page with the highest compression ratio: determine whether the page may be transmitted in time for the transmission timing of transmitting RIP-processed images to the printer; and allocate the page to the other image processing apparatus when the page may be transmitted in time for the transmission timing of transmitting RIP-processed images to the printer.

(8) An eight aspect of the disclosure provides the image processing apparatus according to the sixth aspect, in which the hardware processor may be configured to determine an upper limit of a number of pages to be allocated to the other image processing apparatus in accordance with a ratio of computing power of the image processing apparatus itself to computing power of the other image processing apparatus.

(9) A ninth aspect of the disclosure provides the image processing apparatus according to the sixth aspect, in which the hardware processor may be configured to determine the following as an upper limit of a total value of data sizes of compressed data after RIP processing that may be processed by the other image processing apparatus: data size that may be processed by the other image processing apparatus at the network communication speed of the other image processing apparatus within processing time of RIP processing when all pages of the print job are to be processed by the image processing apparatus itself.

(10) A tenth aspect of the disclosure provides an image processing method of an image processing apparatus that distributes raster image processor (RIP) processing of a print job that may be divided into pages to the image processing apparatus itself and another image processing apparatus with which there may be a network connection. The image processing method may comprise: predicting, for each page of the print job, a state of a RIP-processed image of the page when the other image processing apparatus may be allocated the page for RIP processing; and allocating, for each page of the print job, RIP processing of the page to the image processing apparatus itself or the other image processing apparatus based on the state of a RIP-processed image of the page.

(11) An eleventh aspect of the disclosure provides a non-transitory computer readable storage medium storing a program causing a computer to perform operations of an image processing apparatus that distributes raster image processor (RIP) processing of a print job that may be divided into pages to the image processing apparatus itself and another image processing apparatus with which there may be a network connection. The operations include: predicting, for each page of the print job, a state of a RIP-processed image of the page when the other image processing apparatus is allocated the page for RIP processing; and allocating, for each page of the print job, RIP processing of the page to the image processing apparatus itself or the other image processing apparatus based on the state of a RIP-processed image of the page.

### Effects of Disclosure

According to the disclosure, in a case where RIP processing of a print job is performed in a distributed manner by a plurality of image processing apparatuses connected via a network, it may be possible to prevent degradation in performance when communication speed of the network can restrict the performance.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image processing apparatus that distributes raster image processor (RIP) processing of a print job that is divided into pages to the image processing apparatus itself and another image processing apparatus with which there is a network connection, the image processing apparatus comprising:
a hardware processor, wherein
the hardware processor is configured to:
predict, for each page of the print job, a state of a RIP-processed image of the page when the other image processing apparatus is allocated the page for RIP processing; and
allocate, for each page of the print job, RIP processing of the page to the image processing apparatus itself or the other image processing apparatus based on the state of a RIP-processed image of the page.

2. The image processing apparatus according to claim 1, wherein
the state of a RIP-processed image of the page is a compression ratio when the RIP-processed image is compressed.

3. The image processing apparatus according to claim 1, wherein
the state of a RIP-processed image of the page is a data size of compressed data obtained by compressing the RIP-processed image.

4. The image processing apparatus according to claim 1, wherein
the state of a RIP-processed image of the page is predicted based on object configuration information, the object configuration information including attribute information of an object that constitutes said page, resolution, and a number of one or more objects of said page.

5. The image processing apparatus according to claim 1, wherein
the hardware processor is configured to:
measure a network communication speed between the image processing apparatus itself and the other image processing apparatus; and
allocate, for each page of the print job, RIP processing of the page to the image processing apparatus itself or the other image processing apparatus based on the measured network communication speed and the state of a RIP-processed image of the page.

6. The image processing apparatus according to claim 5, wherein
the hardware processor is configured to:
calculate, as predicted RIP-processing time, time taken to perform RIP processing of each page of the print job by the other image processing apparatus; and
allocate, to the other image processing apparatus, a page that may be transmitted in time for a transmission timing of transmitting RIP-processed images to a printer based on the network communication speed, the state of a RIP-processed image of each page of the print job, and the calculated, predicted RIP-processing time of each page of the print job.

7. The image processing apparatus according to claim 6, wherein
the hardware processor is configured to:
perform the following operations for pages of the print job starting with a page with the highest compression ratio:
determine whether the page may be transmitted in time for the transmission timing of transmitting RIP-processed images to the printer; and
allocate the page to the other image processing apparatus when the page may be transmitted in time for the transmission timing of transmitting RIP-processed images to the printer.

8. The image processing apparatus according to claim 6, wherein
the hardware processor is configured to determine an upper limit of a number of pages to be allocated to the other image processing apparatus in accordance with a ratio of computing power of the image processing apparatus itself to computing power of the other image processing apparatus.

9. The image processing apparatus according to claim 6, wherein
the hardware processor is configured to determine the following as an upper limit of a total value of data sizes of compressed data after RIP processing that may be processed by the other image processing apparatus:
data size that may be processed by the other image processing apparatus at the network communication speed of the other image processing apparatus within processing time of RIP processing when all pages of the print job are to be processed by the image processing apparatus itself.

10. An image processing method of an image processing apparatus that distributes raster image processor (RIP) processing of a print job that is divided into pages to the image processing apparatus itself and another image processing apparatus with which there is a network connection, the image processing method comprising:
predicting, for each page of the print job, a state of a RIP-processed image of the page when the other image processing apparatus is allocated the page for RIP processing; and
allocating, for each page of the print job, RIP processing of the page to the image processing apparatus itself or the other image processing apparatus based on the state of a RIP-processed image of the page.

11. A non-transitory computer readable storage medium storing a program causing a computer to perform operations of an image processing apparatus that distributes raster image processor (RIP) processing of a print job that is divided into pages to the image processing apparatus itself and another image processing apparatus with which there is a network connection, the operations comprising:
predicting, for each page of the print job, a state of a RIP-processed image of the page when the other image processing apparatus is allocated the page for RIP processing; and
allocating, for each page of the print job, RIP processing of the page to the image processing apparatus itself or the other image processing apparatus based on the state of a RIP-processed image of the page.
